(19) United States
(12) Patent Application Publication
(10) Pub. No.: US 2018/0106431 A1
(43) Pub. Date: Apr. 19, 2018

(54) CYLINDER EXCLUSIVE CONNECTION

(71) Applicant: LINDE AKTIENGESELLSCHAFT, München (DE)

(72) Inventors: Felix Timm, Dornstadt (DE); Benjamin Lehnert, Nersingen (DE); Tobias Neuber, Göppingen (DE)

(21) Appl. No.: 15/567,685

(22) PCT Filed: Mar. 23, 2016
(86) PCT No.: PCT/EP2016/000501

§ 371 Date: Oct. 19, 2017

(30) Foreign Application Priority Data
Apr. 20, 2015 (EP) 15001154.2

(51) Int. Cl. F17C 13/06; F17C 13/04; F17C 7/00

(52) U.S. Cl. CPC F17C 13/06; F17C 13/04; F17C 7/00; F17C 2201/058; F17C 2270/0736; F17C 2221/011; F17C 2223/0123; F17C 2223/035; F17C 2205/032

(57) ABSTRACT

A connecting device comprising,
a piercing housing for receiving the neck of a gas cylinder with a top surface comprising a gas outlet
the piercing housing is defined by an opening, side wall and a bottom wall
a piercing member arranged in the piercing housing for piercing the gas outlet of the gas cylinder
a container defining a space for retaining the gas cylinder
a protection cap being provided in the piercing housing which encloses the piercing member partially and can be pushed axially relative to the piercing member, wherein the axial direction coincides with the axis of the gas cylinder, wherein a male portion is provided on the protection cap for connecting the protection cap with the neck of the gas cylinder on which a female portion is present, wherein the female portion has a corresponding shape for being inserted in the male portion, the male portion and the female portion are fitted with each other when a correct position is achieved so that after the fitting the both portions cannot be rotated relative to each other.

The present invention relates to a connecting device comprising,
a piercing housing for receiving the neck of a gas cylinder with a top surface comprising a gas outlet
the piercing housing is defined by an opening, side wall and a bottom wall
a piercing member arranged in the piercing housing for piercing the gas outlet of the gas cylinder
a container defining a space for retaining the gas cylinder
a protection cap being provided in the piercing housing which encloses the piercing member at least partially and can be pushed axially relative to the piercing member, wherein the axial direction coincides with the axis of the gas cylinder

This connecting device is well known to connect the gas cylinder with the said piercing housing having a piercing element therein which is commonly combined with further assemblies in use like tube, valve etc. Gases are frequently supplied in cylinders where the gas is held within a cavity defined by the cylinder walls being enclosed at one end by a pierceable diaphragm. The gas is able to be delivered from the cylinder by attaching a piercing element to the cylinder which causes the diaphragm to be pierced and for the gases to be released from the cylinder. Many commercially available compressed gas cylinders for storing gases are necessarily high pressured and relatively low volume, and thus any loss of the gas in the process of connecting the gas cylinder to the piercing housing or delivery mechanism or after such connection, is undesirable. Therefore, effective sealing is necessary to be provided which prevents the undesirable escape of the compressed gas from the gas cylinder as the gas cylinder is being opened or during the delivery mechanism for a long period of time.

Compressed gas cylinders can be filled with different types of gas such as carbon dioxide, oxygen, helium, nitrogen and other gases. Many different volumes of the gas cylinder have been produced over the years and the gas cylinders have typically two different forms. One form has no threads on the neck of the gas cylinder and is sometimes referred to as a plain neck or non-threaded. The gas cylinder having no threads on the neck can be used in a dispenser utilizing a gas cylinder-retaining container that threads onto a dispenser containing a pierce element and other sealing and fluid controlling means such as U.S. Pat. No. 5,544,670. The second form has threads on the neck of the gas cylinder. For this form a retaining container attached to the dispenser is not necessary and the compressed gas cylinder need only thread into the piercing housing to safely and controllable harness the compressed gas in the cylinder.

As disclosed in U.S. Pat. No. 6,843,388 the Patent teaches some method of how a non-threaded neck compressed gas cylinder can be dispensed with a rigid seal retaining element as well as teaches an additional method of dispensing for a threaded neck compressed gas cylinder. For the non-threaded neck compressed gas cylinder a sealing assembly situates substantially about piercing element for forming a seal between the top surface of the gas cylinder and the piercing element. In using, the gas cylinder will be inserted into piercing element of the dispenser by threading the gas cylinder-retaining container onto the dispenser, so the gas cylinder will be fixed in the position and sealed by the sealing assembly.

The problem of the patent can be, during the gas cylinder-retaining container is being threaded onto the dispenser, the neck of the gas cylinder will rotate simultaneously which inhibits the sealing effect of the neck of the gas cylinder. In this process, the sealing assembly which situates around the piercing element or in the piercing housing could be damaged or undesirable deformed by the friction force resulting from the rotating neck of the gas cylinder which causes an ineffective sealing. In addition, the piercing member could also be damaged by the rotary movement of the gas cylinder.

It is therefore desirable for the sealing assembly to avoid being excessive rubbed by the friction force resulting from the rotary movement of neck of the gas cylinder. The present invention provides a connecting device which does not use a thread-means between the gas cylinder and the piercing housing but use an exclusive connecting means which does not rotate much as the gas cylinder-retaining container is being threaded onto the dispenser.

The present invention provides a connecting device comprising a piercing housing, a piercing member. The gas cylinder is used for holding compressed gases within a cavity defined by cylinder walls. The gas cylinder comprises a gas outlet at its top surface. The gas outlet is preferably enclosed with a pierceable diaphragm. The gas cylinder is so formed that a neck is provided which includes a side surface and a top surface where the gas outlet is obtained.

The piercing housing is provided as a hollow recess sized for allowing the neck of a gas cylinder to be inserted into the housing through the opening of the housing and advance against a piercing member to open the gas outlet of the gas cylinder. The piercing housing is defined by side wall and a bottom wall which is vertical to the axis of the gas cylinder.

The piercing member may be formed as a shaft with a piercing tip in which a channel is provided for leading the gas from the gas cylinder to further mechanism after the piercing of the outlet of the gas cylinder such as a valve or control means.

A protection cap is provided preferably comprising an upper surface and side walls which define an inner space, where the piercing member is at least partially inside. The protection cap situate within the piercing housing in such a way that the upper surface of the protection cap is performed as at least part of the bottom wall of the piercing housing. At the said upper surface an opening is present such that the piercing member can protrude out of the protection cap through the opening by an axially movement of the protection cap. The axially movement will be achieved by pushing the protection cap downwardly. The axis here means coincides with the axis of the gas cylinder when the'gas cylinder stands in a straight line with the piercing housing. The word “downwardly” means towards the piercing housing. Hereafter the “up” refers to the direction from piercing housing to the gas cylinder and the “down” refers to the direction from the gas cylinder to the piercing housing.

The container for retaining the gas cylinder could have an opening at which a thread is present and a chamber defining inside of the container. The chamber is cylinder-shaped and adapted to retain the gas cylinder. A corresponding thread portion may be provided on the exterior side wall of the piercing housing for meshing the container with the piercing housing together, so that the gas cylinder retained in the container can be fixed in the inner space which is defined by the piercing housing and the container. On the other hand, the gas cylinder can advance onto the piercing member by threading the container onto the piercing housing which converts a radially movement to an axially movement. The container may have any size as long as needed for retaining the gas cylinder. Especially the container is sized portable as the gas cylinder which can be held easily by hands.

According to the present invention a gas cylinder is provided which has a preferred small size and designed to be easily portable and disposable e.g. having an overall length of about 6.5 cm to 7.5 cm and a diameter of about 1.5 cm-2 cm. The aspects of the invention may be also used with larger or smaller and/or differently shaped gas cylinder. The cylinder as used herein refers generically to a container which is arranged for storing and releasing gas under pressure. The cylinder has a neck preferably which includes a top surface, an outlet and a side surface. The outlet of the cylinder is preferably enclosed by a breakable surface which can be opened by a piercing element such as a sharpened or blunt lance. The neck of the gas cylinder has a diameter of about 0.5 cm and a length of about 1.5 cm to 2 cm but other sizes are also possible. The pressurized gas in the gas cylinder may be oxygen, carbon dioxide, air, inert gas and mixtures thereof. Such a gas cylinder may be connected with a delivering system which supplies the pressurized gas to a user such as supplying inert gas into a bottle containing liquid for better storage, supplying carbon dioxide into beverage for carbonization or, preferably, introducing oxygen into wine. Pressure ranges for such cylinders can range from around 100 bar to 200 bar and for the most commercial gas cylinder with the aforementioned size and shape the pressure ranges from around 150 bar to 200 bar.

According to the present invention a male portion is provided on the protection cap which is formed preferable with the protection cap as one piece. The female portion which has a corresponding shape as the male portion is present on the neck of the gas cylinder such that the gas cylinder can be connected with the protection cap by fitting the male portion and the female portion together. The fitting process will succeed when the male portion and the female portion reached a correct relative position and after the fitting the both portions cannot be rotated relative to each other which also mean the gas cylinder cannot be rotated relative to the protection cap and the piercing member. The correct position is reached by a downwardly rotation of the female portion wherein the rotation is less than 360°, preferable less than 180°, more preferable less than 120°. It could be 100° C., 90°, 60°, 45° or even less. It could be also possible that under circumstances the female portion can be fitted into the male portion without rotation.

After the correct position is reached, a further downwardly rotation of the female portion is not possible. Thereby a damage of the sealing performance caused by excessive rotation can be avoided. Both male portion and female portion are preferable non-threaded. This little rotation is needed for the male portion and the female portion to be able to orientate itself to reach the correct position. Preferably, the male and female portion are so formed that the the female portion rotates downwardly with a slope of nearly 90°, such as about 85°, 80°, 75° or 70° 60° or 45′ which is much more greater than a thread slope.

The male portion may be formed as an axially upwardly extended wall on the protection cap, preferable on the upper surface of the protection cap. The upper surface is presented preferable in a way that the said opening of the protection cap sits in the center, the said wall which is performed as the male portion sits on the edge of the upper surface and an area between the wall and the opening is also present. The said wall is formed preferable with the protection cap as one piece and is shaped by one or more recesses for fitting with the female portion. The shape of the recesses correspond the shape of the female portion which allows the female portion on the neck of the gas cylinder being able to access into the recesses when a correct positon is reached so that the fitting process can be achieved.

The wall which is performed as the male portion has an upper profile according to the recesses. The said upper profile has preferable no straight lines at the direction which is vertical to the said axis. This special feature allows the female portion being capable to orientate itself to the said correct positon by pushing the gas cylinder downwardly for fitting into the male portion having the said recesses. Preferable the upper profile of the wall has one or more tips or tip-like shapes which facilitate a self-orientating of the gas cylinder having the female portion.

Preferably, the said wall is shaped by at least two recesses which sit opposite each other and have preferable a same shape which could be a curve, a parabola, a part of triangle, symmetrically or unsymmetrically.

A collar-shaped element may be provided on the neck of the gas cylinder which contains the female portion. The collar-shaped element is used to retain the female portion and other possible desirable member to make the neck of the gas cylinder suitable to insert into the piercing housing and for providing a safe and effective sealing at the same time. By installing the collar-shaped element the neck of the gas cylinder has not to be formed complicatedly but can remain the form as usual so an additional produce complex can be avoided. The collar-shaped element contains the female portion corresponding the male portion on the upper surface of the protection cap and an annular internal side wall which is engaged with the neck of the gas cylinder with a variety of connecting means such as threaded, unthreaded, gluing, shrinking fitting and so on. The annular internal wall provides an opening which defines a channel for receiving the piercing member, wherein this collar could be 3 mm to 5 mm longer than usual. In addition, the gas outlet of the gas cylinder can be protected by the channel so that an unawares piercing can be prevented. Such collar could also be provided with sealing assemblies as an O-ring seating in a groove thereon. The collar may be connected with the gas cylinder in a permanent way. The gas cylinder engaged with the said collar may be single used for replacement. The collar contains one or more predetermined breaking points which are designed for make it difficult for pulling the collar off from the neck of the gas cylinder. The predetermined breaking points can be generated in form of one or more hollow spaces in the collar. For instance, on the back side of the collar which opposites the said channel more hollow spaces are provided in the collar. The hollow spaces may be defined by several intermediate plates, When a user attempts to pull the collar off from the neck of the gas cylinder, the collar will get broken due to the rupture of the hollow spaces, which ruins the remove of the collar from the neck of the gas cylinder. This feature can avoid using an incorrect gas cylinder containing incorrect gas so a safe application can be achieved.

The protection cap may contact with one or several springs which are located under the protection cap. During the axially movement of the gas cylinder the spring enable the protection cap to move downwards to allow the gas cylinder to approach the piercing member for piercing the gas outlet. When the gas cylinder is being removed from the piercing member the protection cap supports this movement by the compressed spring to eject the cylinder from the piercing member. This actuation of the protection cap has the advantage that the piercing member will only pierce the correct gas cylinder which is designed to be able to access into the piercing housing and push the protection cap to meet the piercing member.

Preferable, at least one seal assembly is provided surrounding the piercing member which may have a lateral surface and an upper surface. The upper surface of the seal assembly helps create an axially seal between the piercing member and the gas outlet of the gas cylinder. The lateral surface helps to create a radially seal between the piercing member and the neck of the gas cylinder or the collar, especially with the internal side of the channel of the collar. As a result, when the gas cylinder is being pushed into the piercing housing, the piercing member goes via the channel to meet the gas outlet of the gas cylinder and create the axial seal with the gas outlet. The radial seal happens secondary by compressing the axial seal expanding against the inner side of channel of the collar maximizing the sealing performance.

The seal assembly is designed preferable as a High Pressure Seal, sealing up to 200 bar. The seal assembly is used to form a proper seal which can be subjected under high pressure between the piercing member and the top surface of the gas cylinder as well as between the piercing member and the inner side of the collar. The pierced hole represents an opening which must be sealed to guarantee that pressures are kept inside and thereby avoid leaking which might cause accidents, gas losses, among other negative factors. The material of the seal assembly could comprise resin and hardener. The seal effect during the piercing will be improved especially by such a one piece seal assembly which can create both an axial seal and a radial seal simultaneously with a simplified structure.

Preferably, the pressurized gas in the gas cylinder is delivered into a liquid in which the pressurized gas is needed for different purposes such as oxidation, carbonization, inertization etc. The liquid is preferably a wine and the compressed gas is preferably oxygen.

The pressurized gas may contain more than 20% vol. oxygen when measured at atmospheric pressure. It contains preferably more than 50% oxygen, more preferred more than 80% vol., particular preferred more than 90% vol. more particular preferred more than 99% vol. The pressurized gas may be also technical pure oxygen.

It will be appreciated that any form of pressurized gas source may be used. Indeed, the gas cylinder engaged with a collar which is described may be single use with the preferred features and it can be also replaceable or refillable.

The present invention will now be described with reference to the following non-limiting examples and the accompanying schematic figures in which:

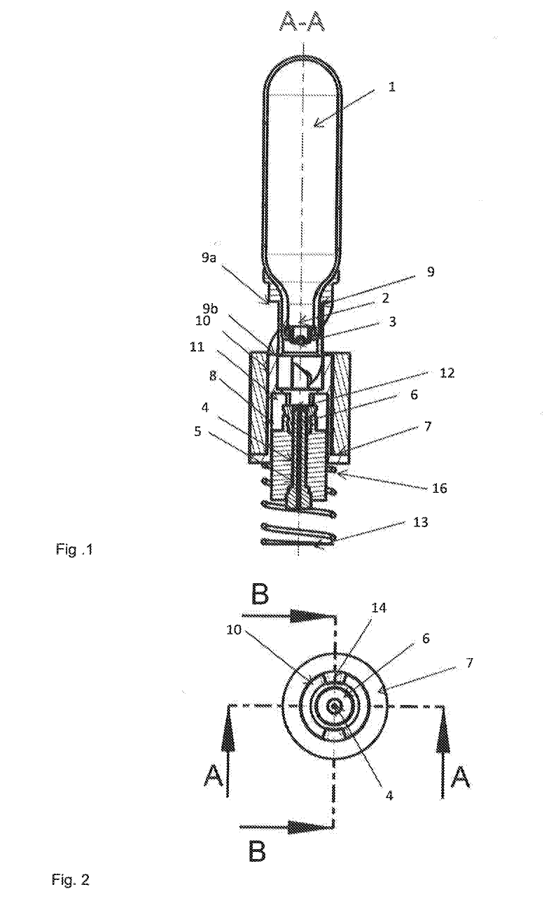

FIG. 1 shows a section view of the connecting device for oxygenating wine without container

FIG. 2 shows a top view of the piercing housing with the protection cap without gas cylinder

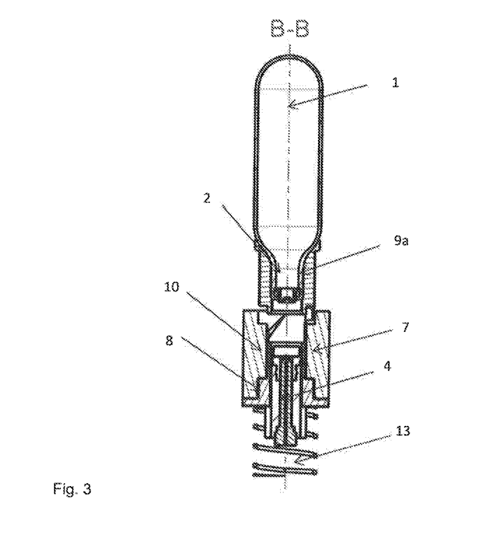

FIG. 3 shows a section view of the piercing housing without gas cylinder and container

FIG. 4 shows an exterior view of the gas cylinder with the collar

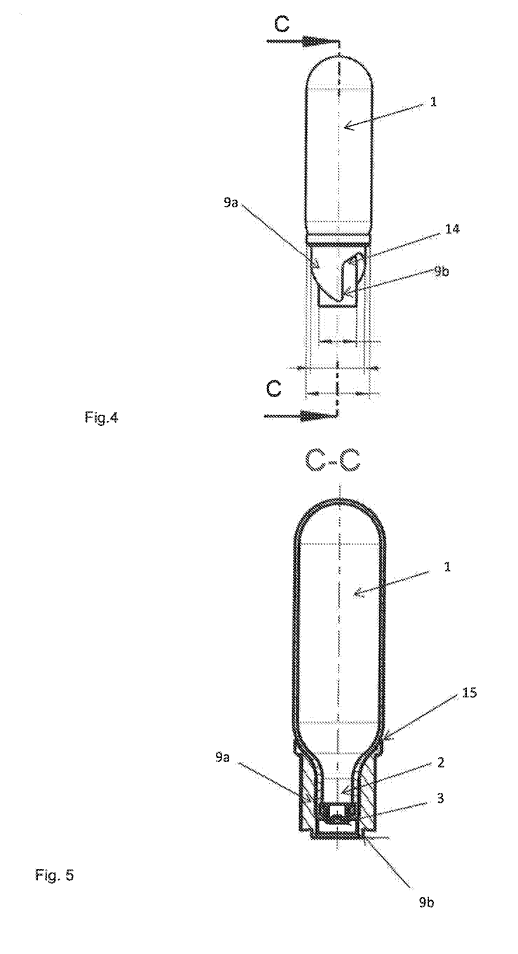

FIG. 5 shows a section view of the gas cylinder with the collar

FIG. 1 shows a part of a hand-held device for introducing oxygen into a bottle of wine. The device shown in the FIG. 1 contains three main parts: a gas cylinder 1, a piercing housing 7, a piercing member 4. The gas cylinder 1 is held by a container which is not shown in the figure. The container has a thread at the opening which correspond a thread on the exterior wall of the piercing housing 7. The container provides an axially force to the gas cylinder 1 by threading on the piercing housing 7 which converts a radially movement to an axially movement. The gas cylinder 1 is filled with pressurized oxygen enclosed by a pierceable diaphragm 3 which can be seen as an outlet for the gas. The gas cylinder is designed to be easily portable and disposable and has an overall length of about 6.5 cm to 7.5 cm and a diameter of about 1.5 cm to 2 cm. In this embodiment, the gas cylinder has a neck 2 which has a smaller diameter of about 0.5 cm to 1 cm than the main body of the gas cylinder 1. The neck 2 is defined by a side wall and a top surface on which the pierceable diaphragm 3 is arranged. A full filled gas cylinder with this size has a pressure between 150 bar and 200 bar. The piercing element 4 is formed as a blunt ended or truncated cone which allows the pierce diaphragm 3 to be deformed quite considerably before rupturing it.

The diaphragm 3 and/or the piercing member 4 are preferably made of a metallic material, for example steel or stainless steel. The piercing member 4 is provided with a channel 5 in the cone which allows the pressurized gas to escape from the gas cylinder 1 and via the channel 5 into further controlling or dispensing assemblies e.g. valve, membrane. Such a piercing of the outlet by means of a blunt end avoids particulate being separated from the outlet during piercing.

The piercing housing 7 is defined by side wall and bottom wall which is sized to allow the neck of the gas cylinder 2 having the collar 9 to be inserted into. In the piercing housing 7 a protection cap 8 is provided comprising an upper surface 11 and side walls which define an inner space to retain the piercing member 4 at least partially inside.

The protection cap 8 is so located in the piercing housing 7 that it can be pushed upwards or downwards in the piercing housing and cannot rotate relative to the piercing member 6. At the upper surface an opening 12 is present which is sized at least so large that the piercing member 6 can protrude out of the protection cap 8 through this opening 12 by pushing the protection cap 8 downwardly by gas cylinder 1. On the other side of the protection cap 8 which opposites the opening 12 some spring 13 are provided. The spring 13 sites under the protection cap 8 and provides an upwards force to the support the protection cap 8 to maintain its position. The spring 13 helps the protection cap 6 to return to its prior position by the biased force of the spring during the removal of the axial force pressing the protection cap 8, thereby the gas cylinder will be pushed off from the piercing member 6 by the protection cap 8 so that the gas cylinder is free and can be removed. The protection cap 8 may have a stop 16 which avoids the protection cap 8 being pushed excessively by the compressed spring 13. On the upper surface 11 a male portion 10 is performed as an axially extended wall which sites on the edge of the upper surface 11 and is formed with protection cap 11 as a single piece. A corresponding female portion 9a is provided on the collar 9 and suitable to fit with the male portion 10 so after the fitting the gas cylinder 1 cannot rotate relative to piercing member 6. The collar 9 has an inner anural surface which is engaged with the neck of the cylinder 2 with a variety of connecting means such as threaded, unthreaded, gluing, and shrinking fitting and so on. The annular internal wall provides an opening which defines a channel 9b for receiving the piercing member 6. A High Pressure (HP) seal 6 is formed as an annular sealing ring surrounding the piercing element 4 which is arranged for preventing the pressurized gas escaping in axial direction and radial direction. It has not to be limited to the HP seal, other sealing forms are also possible.

FIG. 2 shows a top view of the piercing housing 7. The outmost ring-shaped area is the side wall of the piercing housing 7 and the second outmost ring-shaped area is the male portion 10 on the upper surface of the protection cap 8. The forth outmost ring-shaped area is the opening 12 on upper surface of the protection cap 8 and the innermost area is the piercing member 6. The third outmost ring-shaped-area is an area between the male portion 10 and the opening 12 which is designed to meet the area of the channel 9b of the collar when the collar 9 is fitted with the protection cap 8. The FIG. 2 provides two views A and B which are vertical to each other. The FIG. 1 shows the view A and the FIG. 3 shows the view B. The difference between the both views is the male portion 10. The male portion 10 has an upper profile which is formed by two recesses 14 which can be better seen in the FIG. 4. The recesses 14 sit opposite to each other and define the remaining wall in between.

FIG. 3 shows the view B of the FIG. 2 in which the recesses 14 is seen with its section view. This view shows the deep point of the recesses in which the female portion 9a with corresponding profile, which is at the correct position as shown, can be inserted.

On the FIG. 4 a gas cylinder 1 with collar 9 is provided. The collar contains the female portion 9a and the channel 9b. The female portion 9a is shaped by two recesses 14 as shown which have a profile consisting of a half-parabola-like line and a straight line and define the remaining wall which have a sloping shape and can convert an axial force to a radial movement when it is being fitted into the male portion 10 on the protection cap 8. The FIG. 4 provides a C view of the gas cylinder 1 which is shown clearly in the FIG. 5 with a section view. The collar 9 has a female portion 9a and an opening defining a channel 9b for receiving the piercing member 6. On the other side 15 of the collar 9 which opposites the channel 9b one or more hollow spaces (not shown) are provided. The hollow spaces are used to make it difficult for pulling off the collar 9 from the gas cylinder 1. The hollow spaces may be defined by many intermediate plates, so when a user attempts to pull the collar off from the neck of the gas cylinder, the collar 9 will get broken by rupturing the plates, so the remove of the collar fails. This feature can avoid using an incorrect gas cylinder which may contain incorrect gas to ensure a safe and effective aerating.

In the connecting process, the gas cylinder 1 having the specially formed collar 5 on the neck 2 will be inserted into the piercing housing 7. If the gas cylinder is not at the correct position at which the profile of the female portion 9a is not aligned to the profile of the mal portion 10, the gas cylinder will orientate itself by the special shape of the female portion 10 until the correct positon is reached. Once the female portion 9 is fitted with the male portion 10 it is only possibly for a linear axial movement of the gas cylinder 1 relative to the piercing member 4 by threading the container (not shown) which retaining the gas cylinder inside, onto the piercing housing. The piercing member approaches the gas outlet of the gas cylinder via the channel with the linear axial movement and then pieces the gas outlet for delivering the compressed gas from the gas cylinder via the channel 5 of the piercing member 6 to further applications. During this process the HP seal 6 which is arranged around the piercing member 6 creates an axial seal between the gas outlet and the piercing member 6 to prevent the pressurized gas escaping to the atmosphere. Simultaneously, a radial seal happens secondary by compressing the axial seal expanding against the interior side of the channel 9b of the collar maximizing the sealing performance.

During this sealing process the gas cylinder moves only axially without rotary or lateral relative to the piercing member 6 or sealing assemblies which can avoid the undesirable friction force or transverse force caused by the rotation. This rotary movement can lead to damage of the seal assemblies as well as the piercing member which results to leakage or related accident or loss. Additionally, the special formed female portion and male portion can help the user to connect the correct piercing housing and gas cylinder together, so a safe and effective application is secured.

1-15. (canceled)

16. A connecting device, comprising:
a piercing housing for receiving a neck of a gas cylinder with a top surface comprising a gas outlet, the piercing housing defined by an opening, a side wall and a bottom wall;
a piercing member arranged in the piercing housing for piercing the gas outlet of the gas cylinder; and
a protection cap provided in the piercing housing, the protection cap enclosing the piercing member at least partially and axially pushable relative to the piercing member, wherein an axial direction of the protection cap coincides with an axis of the gas cylinder, the protection cap comprising:
a male portion for connecting the protection cap with a female portion of the neck of the gas cylinder, the female portion having a corresponding shape for being inserted in the male portion such that the male and female portions are fitted with each other when a correct position is achieved upon rotation of the female portion to an amount selected from the group consisting of the rotation being less than 360°, and the rotation being less than 180°.

17. The device of claim 16, wherein the male portion comprises an axially upwardly extended wall shaped by at least one recess for allowing the female portion fitting with the male portion.

18. The device of claim 17, wherein an upper profile of the axially upwardly extending wall has no straight lines at a direction which is vertical to the axis such that the female portion is orientable to the correct position by pushing to fit into the male portion.

19. The device of claim 17, wherein the axially upwardly extending wall is shaped by at least two recesses which sit opposite to each other.

20. The device of claim 16, further comprising a collar containing the female portion and which is arranged on the neck of the gas cylinder.

21. The device of claim 20, wherein the collar comprises an opening defining a channel for receiving the piercing member in the channel.

22. The device of claim 16, further comprising at least one spring in contact with the protection cap, the at least one spring providing a force against pushing the gas cylinder onto the protection cap.

23. The device of claim 20, wherein the collar extends beyond the top surface of the gas cylinder.

24. The device of claim 16, further comprising a seal assembly forming an axial seal between the piercing member and the top surface of the gas cylinder and/or to form a radial seal between the piercing member and the neck of the gas cylinder.

25. The device of claim 24, wherein the seal assembly is attached with the piercing member.

26. The device of claim 24, wherein the seal assembly comprises a High Pressure (HP) seal.

27. The device of claim 20, wherein the collar comprises at least one predetermined breaking point.

28. The device of claim 16, wherein the gas cylinder contains a percentage of oxygen selected from the group consisting of more than 21 vol.-% oxygen, more than 80 vol.-% oxygen, and more than 99 vol.-% oxygen.

29. The device of claim 16, further comprising a container defining a space for retaining the gas cylinder, and a screw assembly disposed between the container and the piercing housing to lock together the container retaining the gas cylinder and the piercing housing.

30. A gas cylinder having a collar containing a female portion and arranged on a neck of the gas cylinder, comprising a connecting device, the connecting device comprising:
a piercing housing for receiving the neck of the gas cylinder with a top surface comprising a gas outlet, the piercing housing defined by an opening, a side wall and a bottom wall;
a piercing member arranged in the piercing housing for piercing the gas outlet of the gas cylinder; and
a protection cap provided in the piercing housing, the protection cap enclosing the piercing member at least partially and axially pushable relative to the piercing member, wherein an axial direction of the protection cap coincides with an axis of the gas cylinder, the protection cap comprising:
a male portion for connecting the protection cap with a female portion of the neck of the gas cylinder, the female portion having a corresponding shape for being inserted in the male portion such that the male and female portions are fitted with each other when a correct position is achieved upon rotation of the female portion to an amount selected from the group consisting of the rotation being less than 360°, and the rotation being less than 180°.
